(19) United States
(12) Patent Application Publication
(10) Pub. No.: US 2022/0417619 A1
(43) Pub. Date: Dec. 29, 2022

(54) PROCESSING AND PLAYING CONTROL OVER INTERACTIVE VIDEO

(71) Applicant: GuangZhou Huya Technology Co., Ltd, Guangdong (CN)

(72) Inventor: Junrui LU, Guangdong (CN)

(73) Assignee: GuangZhou Huya Technology Co., Ltd, Guangdong (CN)

(21) Appl. No.: 17/762,282

(22) PCT Filed: Sep. 22, 2020
(86) PCT No.: PCT/CN2020/116677

§ 371 Date: Mar. 21, 2022

(30) Foreign Application Priority Data
Sep. 24, 2019 (CN) 201910906907.7
Sep. 24, 2019 (CN) 201910907638.6

(51) Int. Cl. H04N 21/8541; H04N 21/472; H04N 21/2187; H04L 43/106

(52) U.S. Cl. CPC H04N 21/8541; H04N 21/472; H04N 21/2187; H04L 43/106

(57) ABSTRACT

Embodiments of the present disclosure provide an interactive video play control method, apparatus and system. After a branching message sent by a server is received, it is determined whether a difference between a current play time of playing an interactive video by a client and an execution time is greater than or equal to a preset time threshold, and if the difference is greater than or equal to the preset time threshold, branching options are immediately displayed on the client.

### TECHNICAL FIELD

The present disclosure relates to the technical field of computer software, and in particular, to processing interactive videos and controlling play of interactive videos.

### BACKGROUND

Interactive videos refer to a new type of videos that integrates interactive experience into linear videos through various technical means. FIG. 1 is a schematic diagram illustrating an interactive video in a practical application scenario. When the interactive video is played to a certain paly progress, several branching options can be provided on a play interface for a user to select from the branching options. The user, when watching content of the interactive video on a live broadcast platform, can independently select different branches to watch different plots.

### SUMMARY

According to a first aspect of embodiments of the present disclosure, a live broadcast platform is provided. The live broadcast platform includes: a node editor and a video editor. The node editor is configured to receive a node editing instruction, create a play node according to the node editing instruction and configure a play time offset for each play node, where the play node includes at least one branching node, and at least two child nodes of the at least one branching node. The video editor is configured to receive multiple video files, and respectively associate the video files with multiple play sub-paths between adjacent play nodes to generate an interactive video, where each play sub-path of a same branching node corresponds to multiple parallel plot branches in the interactive video, and the play time offset is configured to control a play progress of playing the interactive video by each client in a live broadcast room, such that a difference between play times of playing the interactive video by any two clients in the live broadcast room is less than a preset value.

According to a second aspect of the embodiments of the present disclosure, an interactive video processing method is provided. Based on the live broadcast platform in any of the embodiments, the method includes: receiving a node editing instruction, creating a play node according to the node editing instruction and setting a play time offset for each play node, where the play node includes at least one branching node, and at least two child nodes of the at least one branching node; receiving multiple video files, and respectively associating the video files with multiple play sub-paths between adjacent play nodes to generate an interactive video, where each play sub-path of a same branching node corresponds to multiple parallel plot branches in the interactive video, and the play time offset is configured to control a play progress of playing the interactive video by each client in a live broadcast room, such that a difference between play times of playing the interactive video by any two clients in the live broadcast room is less than a preset value.

According to a third aspect of the embodiments of the present disclosure, an interactive video play control method is provided, including: receiving a branching message sent by a server when a current script time of an interactive video reaches an execution time when executing a plot branching operation on the interactive video, where the current script time is a time offset of a play time of a current video frame in the interactive video relative to a start play time of the interactive video; determining whether a difference between a current play time of playing the interactive video by a client and the execution time is greater than or equal to a preset time threshold; if the difference is greater than or equal to the preset time threshold, in response to the branching message, displaying branching options on the client.

According to a fourth aspect of the embodiments of the present disclosure, an interactive video play control apparatus is provided, including: a receiving module configured to receive a branching message sent by a server when a current script time of an interactive video reaches an execution time when executing a plot branching operation on the interactive video, where the current script time is a time offset of a play time of a current video frame in the interactive video relative to a start play time of the interactive video; a determining module configured to determine whether a difference between a current play time of playing the interactive video by a client and the execution time is greater than or equal to a preset time threshold; a displaying module configured to, if the difference is greater than or equal to the preset time threshold, in response to the branching message, display branching options on the client.

According to a fifth aspect of the embodiments of the present disclosure, a computer readable storage medium is provided, having a computer program stored thereon, where the computer program is executed by a processor to implement the interactive video play control method in any of the above-described embodiments.

According to a sixth aspect of the embodiments of the present disclosure, a client is provided, including a processor, and a memory for storing a processor executable-computer program, where the computer program is executed by the processor to implement the interactive video play control method in any of the above-described embodiments.

According to a seventh aspect of the embodiments of the present disclosure, an interactive video play control system is provided, including: a server; and a plurality of clients, each of the clients including a processor and a memory for storing a processor-executable computer program, where the computer program is executed by a processor to implement the interactive video play control method in any of the above-described embodiments, where the server is configured to send a branching message to each of the clients when a current script time of an interactive video reaches an execution time of executing a plot branching operation on the interactive video.

It should be understood that the above general description and the following detailed description are only exemplary and explanatory and are not restrictive of the present disclosure.

### BRIEF DESCRIPTION OF THE DRAWINGS

FIG. 1 is a schematic diagram illustrating an interactive video in a practical application scenario.

FIG. 2 is a schematic diagram illustrating a live broadcast platform according to an embodiment of the present disclosure.

FIG. 3 is a schematic diagram illustrating play nodes according to an embodiment of the present disclosure.

FIG. 4a is a schematic diagram illustrating an interactive video editing interface according to an embodiment of the present disclosure.

FIG. 4b is a schematic diagram illustrating an interactive video editing interface according to another embodiment of the present disclosure.

FIG. 5 is a schematic diagram illustrating play times and play numbers of interactive videos according to an embodiment of the present disclosure.

FIG. 6 is a schematic diagram illustrating a bullet-screen comment message displayed on a client according to an embodiment of the present disclosure.

FIG. 7a is a schematic diagram illustrating bullet-screen comment messages displayed on a client according to another embodiment of the present disclosure.

FIG. 7b is a schematic diagram illustrating bullet-screen comment messages displayed on a client according to still another embodiment of the present disclosure.

FIG. 8 is a schematic diagram illustrating a live broadcast platform according to another embodiment of the present disclosure.

FIG. 9 is an architecture diagram illustrating partial functions of a live broadcast platform according to an embodiment of the present disclosure.

FIG. 10 is a schematic diagram illustrating an interactive video creation process according to an embodiment of the present disclosure.

FIG. 11 is a schematic diagram illustrating an interactive video play process according to an embodiment of the present disclosure.

FIG. 12 is an architecture diagram illustrating an overall function of a live broadcast platform according to an embodiment of the present disclosure.

FIG. 13 is a flowchart illustrating an interactive video processing method according to an embodiment of the present disclosure.

FIG. 14 is a flowchart illustrating an interactive video play control method according to an embodiment of the present disclosure.

FIG. 15 is a schematic diagram illustrating play processes of clients with different play delays according to an embodiment of the present disclosure.

FIG. 16 is a block diagram illustrating an interactive video play control apparatus according to an embodiment of the present disclosure.

FIG. 17 is a schematic structural diagram illustrating a computer device for implementing an interactive video play control method according to an embodiment of the present disclosure.

FIG. 18 is a schematic diagram illustrating an interactive video play control system according to an embodiment of the present disclosure.

### DETAILED DESCRIPTION OF THE EMBODIMENTS

Examples will be described in detail herein, with the illustrations thereof represented in the drawings. When the following descriptions involve the drawings, same numerals in different drawings refer to same or similar elements unless otherwise indicated. The embodiments described in the following examples do not represent all embodiments consistent with the present disclosure. Rather, they are merely examples of apparatuses and methods consistent with some aspects of the present disclosure as detailed in the appended claims.

The terms used in the present disclosure are for the purpose of describing particular embodiments only, and are not intended to limit the present disclosure. Terms determined by “a”, “the” and “said” in their singular forms in the present disclosure and the appended claims are also intended to include plurality, unless clearly indicated otherwise in the context. It should also be understood that the term “and/or” as used herein refers to and includes any and all possible combinations of one or more of the associated listed items.

It is to be understood that, although terms “first,” “second,” “third,” and the like may be used in the present disclosure to describe various information, such information should not be limited to these terms. These terms are only used to distinguish one category of information from another. For example, without departing from the scope of the present disclosure, first information may be referred as second information; and similarly, second information may also be referred as first information. Depending on the context, the word “if” as used herein may be interpreted as “when” or “upon” or “in response to determining”.

Definitions of terms used in the present disclosure are as follows.

Play node (referred to as node): that is, nodes arranged and associated according to a certain organizational structure. The nodes can be pre-defined when interactive videos are made. One interactive video needs at least 3 nodes, that is, one branching node and at least two child nodes corresponding to the branching node (where the branching node is a parent node of the two child nodes), and the interactive video may further include other nodes, such as aggregation nodes and common nodes. Where a node including multiple child nodes is a branching node. A node including multiple parent nodes is an aggregation node. A node including at most only one parent node and at most only one child node is a non-branching node. According to positions of nodes, the nodes can be divided into a start node, an intermediate node and an end node. The start node is a root node, and the start node has no parent node. The end node is a leaf node, and the end node has no child nodes. A node that has both the child node and the parent node is the intermediate node.

FIG. 3 is a schematic diagram illustrating play nodes according to one or more embodiments. In the diagram, 8 play nodes S, R, A, B, E1, E2, E3 and E4 are included. The node S is a start node. The node R is an intermediate node. The nodes A and B are child nodes of the node R. The nodes E1 and E2 are child nodes of the node A. The nodes E3 and E4 are child nodes of the node B. The node S is a non-branching node. The nodes R, A and B are branching nodes. The nodes E1, E2, E3 and E4 are end nodes.

Adjacent play node: one play node and its parent node are adjacent play nodes to each other, and similarly, one play node and its child nodes are adjacent play nodes to each other.

Play path: a path connecting two play nodes. For example, as shown in FIG. 3, a path connecting the node S and the node R is a play path SR between the node S and the node R. For another example, a path connecting the node S and the node A is a play path SR→RA between the node S and the node A. A play path between two adjacent play nodes is also called a play sub-path. In FIG. 3, the SR is a play sub-path between the play node S and the play node R, and the RA is a play sub-path between the play node R and the play node A. Both a branching node and an aggregation node include multiple play paths, and a common node includes one play path. Play paths between one node and its child nodes are called play paths dependent to the node. Play paths dependent to the child nodes of the node are also play paths dependent to the node.

One interactive video can include multiple video files. Each play sub-path corresponds to one video file of the interactive video. Video files corresponding to all play sub-paths constitute video content of the interactive video. Play nodes and play paths between play nodes constitute play logic of the interactive video. Multiple play sub-paths dependent to the same branching node are parallel play sub-paths. Multiple parallel play sub-paths correspond to multiple parallel branching plots in the interactive video. A user can select one of the play sub-paths to independently select a plot direction of the interactive video. For example, in the play nodes shown in FIG. 3, at the node R, a user can select an option corresponding to RA to play a branching plot corresponding to the RA in the interactive video; at the node A, the user can select an option corresponding to AE1 to play a branching plot corresponding to the AE1 in the interactive video.

Historical selection path: a play path that a user has selected during watching of an interactive video. For example, if, at the node R, the user selects the option corresponding to the RA, a historical selection path of the user is SR→RA. If the user has not selected a play path, the historical selection path is empty.

Current play path: a play sub-path which is being played at the current moment. For example, when a play path of an interactive video is SR→RA, and a video file corresponding to RA is currently being played, the RA is the current play path.

Default play path: each branching node corresponds to one default play path. If a user does not select a play path within a preset time period, a system will automatically select a preset play path (i.e., the default play path) to play for the user until the user re-selects a play path. For example, in FIG. 3, a default play path of the node R can be set to RA, and a default play path of the node B can be set to BE3. A path between two adjacent play nodes on the default play path is a default play sub-path.

Target play path is a next play sub-path to be played. The target play path can be independently selected by a user. If the user does not select the target play path within a preset time period, the default play path is taken as the target play path. For example, at the node R, if the user selects RB, the RB is the target play path; if the user does not make a selection at the node R, the default play path RA of the node R is taken as the target play path.

Play time offset: that is, a time offset between a current play time of an interactive video and a start play time of the interactive video. For example, if the interactive video starts to be played at 20:00:00, and the current play time is 20:10:00, the play time offset is 10 minutes.

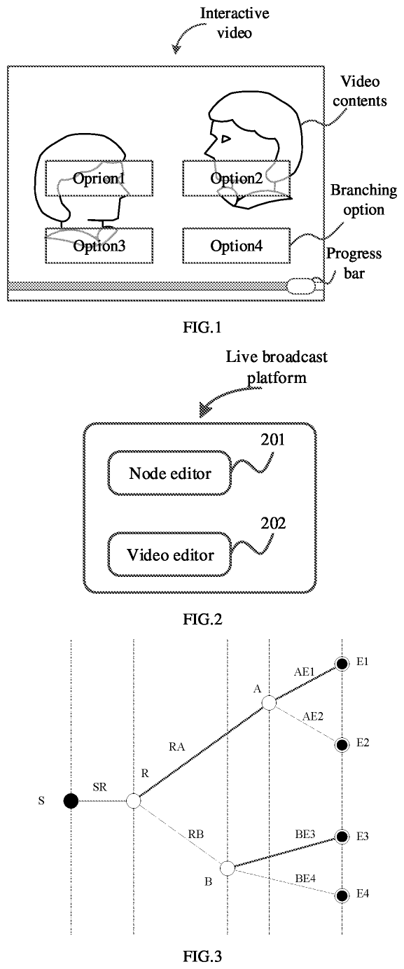

FIG. 2 is a schematic diagram illustrating a live broadcast platform according to an embodiment of the present disclosure. The live broadcast platform may include: a node editor 201 and a video editor 202.

The node editor 201 is configured to receive a node editing instruction, create a play node according to the node editing instruction and configure a play time offset for each play node, where the play node includes at least one branching node, and at least two child nodes of the at least one branching node.

The video editor 202 is configured to receive multiple video files, and associate each video file respectively with each corresponding sub-path of multiple play sub-paths between adjacent play nodes to generate an interactive video, where each play sub-path of a same branching node corresponds to multiple parallel plot branches in the interactive video, and the play time offset is configured to control a play progress of playing the interactive video for each client in a live broadcast room, such that a difference between play times of playing the interactive video by any two clients in the live broadcast room is less than a preset value.

In the embodiment, the live broadcast platform can directly or indirectly receive instructions sent by operation-maintenance personnel or directors to implement the process of creating, editing, publishing and playing interactive videos.

The node editor 201 can receive a node editing instruction sent by the operation-maintenance personnel or the directors, where the node editing instruction can include a play time offset of a play node, that is, a time difference between a time when an interactive video is played to the play node and a start play time of the interactive video. For example, if the start play time of the interactive video is 20:00:00, and a time when the interactive video is played to the first play node is 20:10:00, a play time offset of the first play node is 10 minutes. Playing an interactive video to a play node means starting to play a video file associated with a play sub-path constituted by the play node and its child node in the interactive video.

Further, the node editing instruction can include a node type of the play node. Node types may include branching nodes, aggregation nodes (also called convergence nodes) and common nodes. A branching node may be a play node that has multiple child nodes. An aggregation node may be a play node that has multiple parent nodes. A common node may be a play node that has one parent node and one child node, or be a play node that has only one parent node without a child node (i.e., an end node), or be a play node that has only one child node without a parent node (i.e., a start node). For a branching node, the node editing instruction can further include a branch number of the branching node. Each branch of the branching node corresponds to one child node. Branches of a branching node correspond to parallel plot branches of the branching node in the interactive video.

Play nodes in an interactive video include at least one branching node and two branches corresponding to the branching node, that is, the interactive video includes at least 3 nodes (one branching node and at least two child nodes corresponding to the branching node). In practical applications, the interactive video may further include other types of nodes, for example, aggregation nodes and/or common nodes. Play nodes shown in FIG. 3 include common nodes S, E1, E2, E3 and E4, and further include branching nodes R, A and B.

After the play nodes are defined, the video editor 202 can receive video files uploaded by the operation-maintenance personnel or the director, and respectively associate each video file with each corresponding play sub-path of multiple play sub-paths between adjacent play nodes. The video editor 202 can acquire URLs (Uniform Resource Locators) of video files input by the operation-maintenance personnel or the director, and acquire corresponding video files by accessing the URLs.

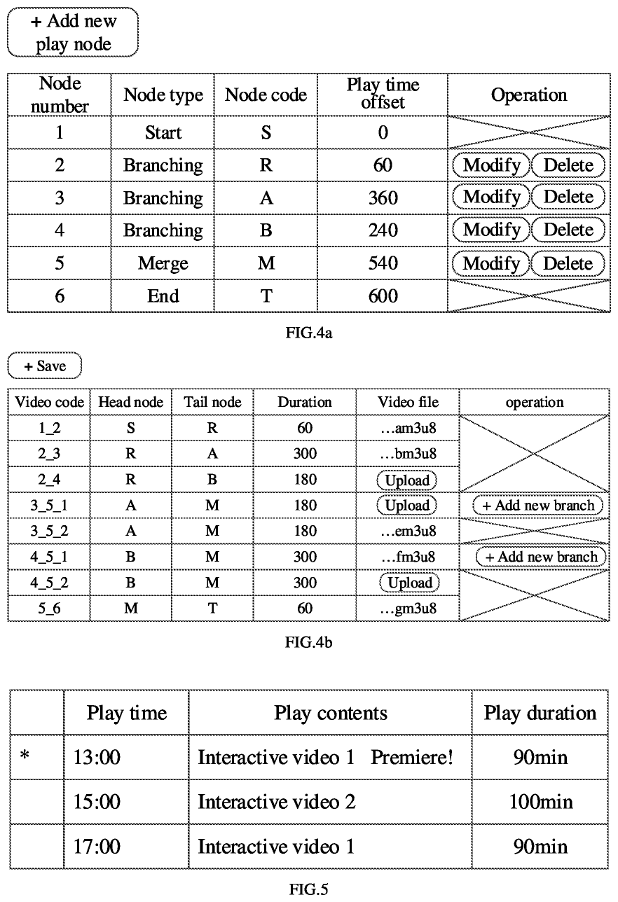

FIG. 4a and FIG. 4b are schematic diagrams illustrating an interactive video editing interface according to one or more embodiments, which are schematic diagrams of editing interfaces of an interactive video that includes only two play paths SR→RA→AM→MT and SR→RB→BM→MT. FIG. 4a is a schematic diagram illustrating a node editing interface according to an embodiment. In FIG. 4a, a node creation component is included. By sending an instruction to the node creation component (for example, by clicking the component with a mouse), a new play node can be added. Created play nodes can be displayed in a play node list in order. The play node list may include a serial number, a type, a node code and a play time offset of each play node. Each play node can correspond to one node modification component and one node deletion component. By sending an instruction to the node modification component, the type, the node code and the play time offset of corresponding play node can be modified. By sending an instruction to the node deletion component, corresponding play node can be deleted.

FIG. 4b is a schematic diagram illustrating a video uploading interface according to an embodiment. For nodes created during node edition, a path between adjacent nodes is a play sub-path, and one video file can be uploaded for each play sub-path. For example, one video file can be uploaded for a path between node R and node A in FIG. 4a, and a code of the video file can be recorded as 2_3, where 2 is a serial number of a head node (i.e., the node R) on this play sub-path, and 3 is a serial number of a tail node (i.e., the node A) on this play sub-path. The head node is a start node on the play sub-path, and the tail node is an end node on the play sub-path. For a branching node, a code of a video file corresponding to each branch of the branching node may include a serial number corresponding to the number of branches. For example, 3_5_1 represents a video file corresponding to a first branch between a play node with a serial number 3 and a play node with a serial number 5. Each branching node may be set with a new branch adding component, which is configured to add a new branch to the branching node.

In this embodiment, by defining play nodes, organizational structures and play paths of video files in an interactive video can be determined. In the play nodes shown in FIG. 3, there are 4 play paths: SR→RA→AE1, SR→RA→AE2, SR→RB→BE3 and SR→RB→BE4. In addition, by setting a play time offset for each play node, a virtual timeline (i.e., a script timeline) can be constructed. The significance of the script timeline is that a time offset (a time difference) between a play time of each frame of video frames in an interactive video and a start play time of the interactive video can be determined. This time offset is related to a duration of each video file in the interactive video and a play path of the interactive video, and is not related to whether a network of a client is in good condition. That is to say, after the interactive video has been edited, the frame to be played at a certain time of the interactive video has been fixed.

If, due to network lag or the like, there is a great difference between an actual play time of an interactive video played currently by a client and a play time offset of the interactive video on a script timeline, by skipping some frames of the interactive video ( [symbol] [symbol] ) or adjusting a time reserved for the client to select a play path, the progress bar or play progress of the interactive video played by the client can be controlled so as to reduce the delay of playing the interactive video by the client. In this way, the progress bars or play progresses for each of clients of the interactive video can be relatively unified, which is convenient for each client to discuss plots on a relatively unified timeline, and increases the interactivity of live broadcast.

FIG. 8 is a schematic diagram illustrating a live broadcast platform according to another embodiment of the present disclosure. The live broadcast platform further includes a video manager 203 configured to receive play time information and play number information of each interactive video, and associate the play time information and the play number information of each interactive video with corresponding interactive video. FIG. 5 is a schematic diagram illustrating play times and play numbers of interactive videos according to an embodiment of the present disclosure. In FIG. 5, an interactive video 1 is played respectively at 13:00 and 17:00 for a duration of 90 minutes, and the play at 13:00 is a premiere. An interactive video 2 is played at 15:00 for a duration of 100 minutes. By playing the same interactive video at different times (e.g., different play numbers), users who are late for a previous session can watch previously unwatched plot contents from start at other times, which improves the user experience. For example, a user entered a live broadcast room at 13:10, when the interactive video 1 was premiered, the user missed plots in the first 10 minutes. Therefore, the user can enter the live broadcast room before 17:00 to watch the plots in the first 10 minutes of the interactive video 1.

In one or more embodiments, the live broadcast platform further includes an instructor console 204 configured to, during playing of the interactive video, in response to a received interactive video editing instruction, insert a play node in the interactive video, delete a play node from the interactive video, and/or insert an advertisement in the interactive video.

In this embodiment, part of control authority on an interactive video can be opened to the operation-maintenance personnel or the director, and the operation-maintenance personnel or the director manually sends an instruction to edit the interactive video. The operation-maintenance personnel or the director can send an interactive video editing instruction to a live broadcast platform. The interactive video editing instruction can be a play node insertion instruction, a play node deletion instruction, an advertisement insertion instruction or other types of instructions. After receiving the interactive video editing instruction, the live broadcast platform can correspondingly insert a play node, delete a play node, or insert an advertisement in the interactive video.

In one or more embodiments, the instructor console 204 is further configured to count a number of instruction operations performed by one or more clients playing the interactive video; and/or count a number of clients on each play sub-path. In this embodiment, the instructor console 204 can count the number of instruction operations performed by each client. The instruction operations mentioned here may include an instruction operation of selecting a play path, and may further include an instruction operation of enabling or disabling a bullet chat isolation function, an instruction operation of enabling or disabling a bullet chat spoiler prevention function, etc. The instructor console 204 can count the number of clients on each play sub-path, e.g., how many clients are playing a video file corresponding to a path SR, how many clients are playing a video file corresponding to a path RA, etc.

In one or more embodiments, the live broadcast platform further includes an instruction controller 205 configured to acquire a server time, and if the server time reaches a play time indicated by play time information of an interactive video, send an interactive video play start instruction to a client through a long connection pre-established with the client, where the interactive video play start instruction is configured to instruct the client to access a video address of the interactive video to start to play the interactive video.

The live broadcast platform can maintain one video play list (i.e., a program list). The video play list is configured to record play time information and play number information of each interactive video. The play time information and the play number information of each interactive video are loaded into the instruction controller 205. For clients that are already in a live broadcast room before an interactive video starts to be played, the clients can establish a long connection with the live broadcast platform when entering the live broadcast room, and monitor information sent through the long connection to wait for a unified play start instruction. The instruction controller 205 cyclically automatically performs operations determining whether a current sever time reaches a play time, and when determining that a current server time reaches a play time, sends a play start instruction to each client on time. The play start instruction includes an address of a video file (for example, a video file in m3u8 format) that needs to be played. After the client accesses the address, corresponding video file will start to be played.

In one or more embodiments, the instruction controller 205 is further configured to, in response to receiving a short connection establishment request sent by the client, establish a short connection with the client, and through the short connection, receive a play request instruction of the interactive video sent by the client that request for starting to play the interactive video.

For clients that enter a live broadcast room after an interactive video has started to be played in the live broadcast room (users who are late), after entering the live broadcast room, the clients can send a short connection establishment request to the live broadcast platform. The instruction controller 205 can establish a short connection with the clients, and receive a play request sent by the clients through the short connection. In response to the received the play request, the instruction controller 205 can send a play start instruction to the clients, so that the clients start to play the interactive video. In addition, if the clients are disconnected from a network while the interactive video are being played, when the clients get connected from a network again, the clients can actively send a play request to the live broadcast platform through the short connection. The instruction controller 205 of the live broadcast platform, in response to the received play request, can send a resuming play instruction to the clients, so that the clients continue to play the interactive video.

In one or more embodiments, the live broadcast platform further includes: a bullet chat processor 206 configured to acquire bullet-screen comment messages sent by a client, and acquire a current play path of playing the interactive video on which the client sends the bullet-screen comment messages, and send the bullet-screen comment messages to other clients on the current play path.

In this embodiment, the bullet chat processor 206 can send bullet-screen comment messages (which allows real-time comments from clients to fly across the screen like bullets) sent by one client to clients on a same current play path. For example, if current play paths for both client 1 and client 2 are RA, and the client 1 sends a bullet-screen comment message “What a nice day today”, the bullet chat processor 206 can send the bullet-screen comment message “What a nice day today” to the client 2 for display.

Further, if the current play paths for client 1 and client 2 are different, the bullet chat processor 206, when receiving a bullet-screen comment message sent by the client 1, will isolate the bullet-screen comment message from the client 2. That is, the bullet chat processor 206 filters out and shields the bullet-screen comment message sent by the client 1, to prevent the bullet-screen comment message sent by the client 1 from being sent to the client 2.

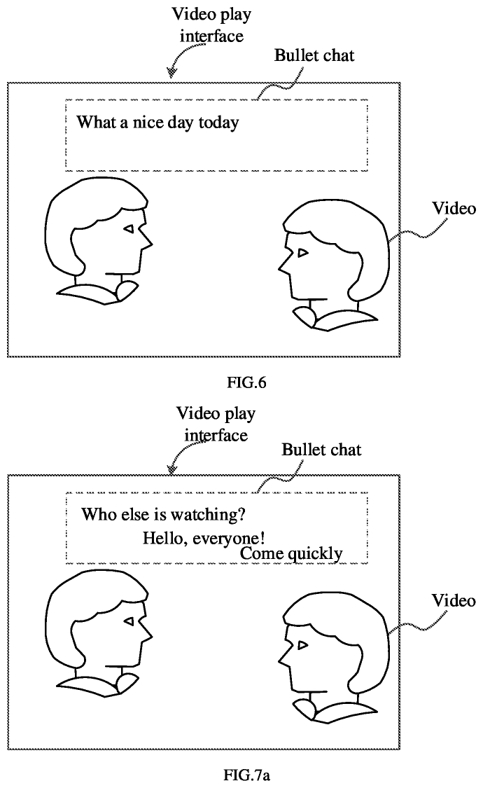

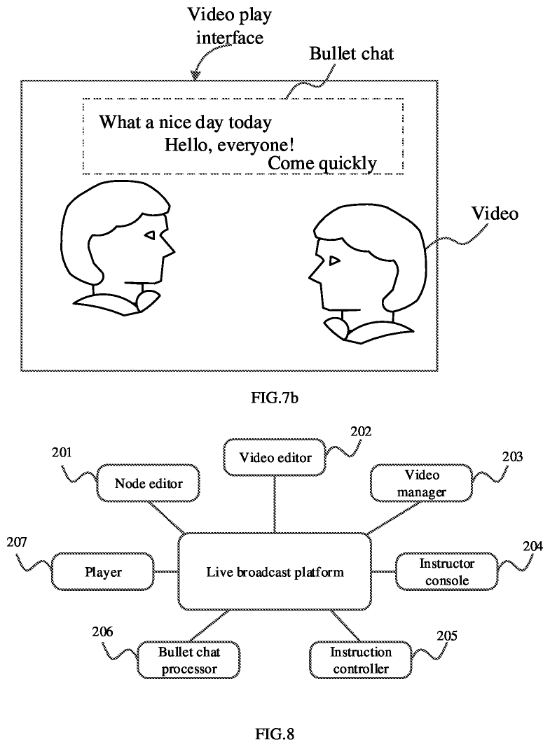

FIG. 6 and FIG. 7a are schematic diagrams illustrating bullet-screen comment messages displayed on clients. e.g., a user 1, who is watching the interactive video on the play sub-path RA, sends a bullet-screen comment message “What a nice day today”, a user 2, who is watching the interactive video on the play sub-path RB, sends bullet-screen comment messages “Hello, everyone!” and “Come quickly”, and a user 3, who is watching the interactive video on the play sub-path RB sends a bullet-screen comment message “Who else is watching?”, the bullet-screen comment messages sent by the user 2 and the user 3 are shielded on a play interface of the user 1, as shown in FIG. 6, and the bullet-screen comment message sent by the user 1 is invisible on play interfaces of the user 2 and the user 3, as shown in FIG. 7a.

By shielding bullet-screen comment messages sent by clients on different play paths, the bullet chat isolation function enables the clients to display only bullet-screen comment messages sent by clients on a same play path. On one hand, shielding the bullet-screen comment messages sent by clients on different play paths reduces a number of bullet-screen comment messages, and avoids interference with video play due to too many bullet-screen comment messages. On the other hand, because the clients on different play paths play different plot branches of an interactive video, isolating bullet-screen comment messages can prevent a spoiler to users who watch different plot branches, and facilitate communication through bullet-screen comment messages from users who watch the same plot branch on the same play path, which increases the interactivity during play of the interactive video, and improves the user experience.

In one or more embodiments, the bullet chat processor 206 is further configured to: acquire a second time offset between a time when a second client sends the bullet-screen comment messages and a start play time of the interactive video, and send the bullet-screen comment messages to a first client, where a first time offset between a current play time and a start play time of the interactive video on the first client is less than the second time offset.

The second client, when sending bullet-screen comment messages, will associate a time point of sending the bullet-screen comment messages with the bullet-screen comment messages, and then send the bullet-screen comment messages to a server. After receiving the bullet-screen comment messages, the server can analyze the time point associated with the bullet-screen comment messages to obtain a second time offset. The second time offset can represent the time (for the progress bar of an interactive video) until when an interactive video has been played when the second client sends the bullet-screen comment messages.

In addition, the server can acquire a first time offset of an interactive video played currently by the first client in a same live broadcast room. The first time offset can represent the time or moment (for the progress bar of an interactive video) until when an interactive video has been played on a first client.

If the second time offset is greater than the first time offset, it may indicate that the play progress of an interactive video played on the second client is faster than the play progress of an interactive video played on the first client. For example, the first time offset is 00:20:00, and the second time offset is 00:30:00, it may indicate that, the interactive video played on the first client has been played until 00:20:00 (of the progress bar). While the interactive video played on the second client has been played until 00:30:00 (of the progress bar). That is to say, the play progress on the second client is 10 minutes faster than the play progress on the first client.

In the above situation, since the second client has played subsequent plots of video contents currently being played by the first client, bullet-screen comment messages sent by the second client may cause a spoiler to users of the first client. In order to prevent the above situation from happening, the bullet-screen comment messages sent by the second client can be isolated on the first client, that is, the server intercepts the bullet-screen comment messages sent by the second client to prevent the bullet-screen comment messages sent by the second client from being displayed on the first client.

Assuming that a user 1 sends a bullet-screen comment message “What a nice day today” through a client 1, a user 2 sends bullet-screen comment messages “Hello, everyone!” and “Come quickly” through a client 2, a user 3 sends a bullet-screen comment message “Who else is watching?” through a client 3, the client 1 currently plays 00:10:00 of an interactive video, the client 2 currently plays 00:20:00 of the interactive video, and the client 3 currently plays 00:30:00 of the interactive video, the bullet-screen comment messages sent through the client 2 and the client 3 are isolated on a play interface of the client 1, as shown in FIG. 6, and only the bullet-screen comment message sent through the client 3 is isolated on a play interface of the client 2, as shown in FIG. 7b.

In the solution of this embodiment, by acquiring the second time offset of the second client and the first time offset of the first client, and isolating the bullet-screen comment messages sent by the second client on the first client with the first time offset less than the second time offset, it can be prevented that the bullet-screen comment messages sent by the second client with a faster play progress cause a spoiler to users of the first client with a slower play progress, which improves the user experience of watching an interactive video.

In one or more embodiments, the live broadcast platform further includes a player 207 configured to receive a play path selection instruction from the client, determine a target play sub-path of the interactive video according to the play path selection instruction, and send a URL of a video file associated with the target play sub-path to the client.

Assuming that a play node R has a play sub-path RA and a play sub-path RB, and a target play sub-path determined according to a play path selection instruction is the play sub-path RB, a URL of a video file associated with the play sub-path RB is sent to a client.

Further, if a play path selection instruction of a client is not received within a preset time period, a URL of a video file associated with a default play sub-path is sent to the client. Assuming that a play node R has a play sub-path RA and a play sub-path RB, where the RA is a default play sub-path of the node R, if a play path selection instruction sent by a client is not received within a preset time period, a URL of a video file associated with the RA is sent to the client.

In an embodiment, the player 207 is further configured to send the current script time (the script time is the time corresponding to the script timeline) of the interactive video to the client; the client is configured to, when a difference between the current script time and an actual play time of currently playing the interactive video is greater than a preset time threshold, skipping some frames of the interactive video according to the server.

The script time is the time on the script timeline. As mentioned earlier, the script timeline is determined based on a time offset (a time difference) between a play time of each video frame in an interactive video and a start play time of the interactive video. The script time is equivalent to a play time on a client in an ideal status. The client in the ideal status has no network delay, and the play is not lagging. However, in actual situations, due to network delay and lag, an actual play time on a client is generally later than a script time, and actual play time on different clients are generally different.

For example, according to a preset script time, an interactive video shall start to be played at 18:00:00, and progress to a branching node R at 18:01:00. If a play path RB is selected, the interactive video progresses to a branching node B via the play path RB at 18:04:00. If a play path RA is selected, the interactive video progresses to a branching node A via the play path RA at 18:06:00.

The network of a client 1 is in a normal condition and occasionally lagging. The client 1 starts to play at 18:00:08 after its network is lagging for 8 seconds. The client 1 receives a branching message of a play node R sent by a live broadcast platform at 18:01:00, and selection components for selecting a play path after the node R are displayed on a play interface of the client at 18:01:08. If the client 1 selects a play path RB, a branching message of a play node B sent by the live broadcast platform is received at 18:04:00, and selection components for selecting a play path after the node B are displayed on the play interface of the client at 18:04:08. If the client 1 selects a play path RA, a branching message of a play node A sent by the live broadcast platform is received at 18:06:00, and selection components for selecting a play path of the node A are displayed on the play interface of the client at 18:06:08.

The network of a client 2 is in an extremely poor condition and buffering is often required. The client 2 starts to play at 18:00:20 after its network is lagging for 20 seconds (assuming that a preset time threshold is 10 seconds). The client 2 receives a branching message of a play node R sent by a live broadcast platform at 18:01:00. In order to reduce play delay, the client 2 can skip some frames of the interactive video after receiving the branching message of the play node R, and selection components for selecting a play path after the node R are immediately displayed on a play interface of the client at 18:01:10 (so that, only 10 seconds of play delay remain by skipping some frames of the interactive video). If the client 2 selects a play path RB, a branching message of a play node B sent by the live broadcast platform is received at 18:04:00, and selection components for selecting a play path after the node B are displayed on the play interface of the client at 18:04:10. If the client 2 selects a play path RA, a branching message of a play node A sent by the live broadcast platform is received at 18:06:00, and selection components for selecting a play path after the node A are displayed on the play interface of the client at 18:06:10.

Some frames of the interactive video may be skipped actively by a client after receiving a branching message. Specifically, the client can acquire a current script time t1, and a current play time t2 on this client. If a difference between the t1 and the t2 is greater than a threshold (i.e., a tolerance duration), the player on the client continues to play immediately from the time point t1. If a lag duration is less than the tolerance duration, some frames of the interactive video is not skipped by the client.

Some frames of the interactive video may be skipped passively. For example, a live broadcast platform sends a heartbeat packet to a client regularly (for example, every 3 seconds), and the client receives the heartbeat packet to detect whether a difference between a current play time on the client and a current script time exceeds a tolerance duration. If the difference between the current play time on the client and the current script time exceeds the tolerance duration, the client skips some frames of the interactive video, and otherwise, the client does not skip some frames of the interactive video.

In an embodiment, the player 207 is further configured to acquire a bullet chat white list of a first client, where the bullet chat white list is used to store a list of preset play paths, and bullet-screen comment messages sent by any client on the preset play paths are allowed to be displayed on the first client. When the bullet chat processor 206 receives bullet-screen comment messages sent by a second client, the player 207 determines whether a current play path of the second client is in the bullet chat white list. If the current play path of the second client is not in the bullet chat white list, the bullet-screen comment messages sent by the second client are prevented from being sent to the first client, so that the first client does not display the bullet-screen comment messages sent by the second client.

Further, if the current play path of the second client is in the bullet chat white list, the first client can display the bullet-screen comment messages sent by the second client.

In this embodiment, the first client can further display bullet-screen comment messages sent by the second client which is on a different current play path from the first client, and the current play path on which the second client is can be pre-stored in the bullet chat white list (i.e., a preset play path set in the bullet chat white list of the first client). The preset play path may be a play sub-path dependent to the same branching node as the current play path of the first client, or a play sub-path under other branching nodes. The preset play path can be defined by the user, or a default preset play path can be used. The default preset play path may be the play sub-path dependent to the same branching node as the current play path of the first client.

The first client can enable a bullet chat white list function. After the bullet chat white list function is enabled, if the preset play path is not edited, the default preset play path will be used. If the preset play path has been edited, the edited preset play path will be used.

In this embodiment, users can independently select a source of bullet chats. For example, when a user wants to watch comments of other users on different play sub-paths corresponding to the same branching node, the play sub-paths corresponding to the same branching node can be added to the bullet chat white list. This bullet chat isolation method is more flexible, and further improves the user experience.

In an embodiment, the player 207 is further configured to store a bullet chat functioning scope for each play node, and when a current play path for a first client is within the bullet chat functioning scope, prevent bullet-screen comment messages sent by a second client for which current play path is not within the bullet chat functioning scope from being sent to the first client.

In this embodiment, each node corresponds to one bullet chat functioning scope. The bullet chat functioning scope is used to store a list of play paths. The play paths in the list satisfy: bullet-screen comment messages sent by each client on a same play path can be displayed on other clients on this play path.

Take play nodes shown in FIG. 3 as an example. Assuming that a bullet chat functioning scope for a play node R is RA, current play paths for a client 1 and a client 2 are RA, and a current play path for a client 3 is RB, since the current play paths for the client 1 and the client 2 are within the same bullet chat functioning scope, bullet-screen comment messages sent by the client 1 and the client 2 can be displayed on the client 1. Similarly, the bullet-screen comment messages sent by the client 1 and the client 2 can be displayed on the client 2. Since the client 3 is outside the bullet chat functioning scope, only bullet-screen comment messages sent by the client 3 are displayed on the client 3, and the bullet-screen comment messages sent by the client 1 and the client 2 are not displayed on the client 3.

In an embodiment, the player 207 is further configured to update play paths for the client. Specifically, for a default play path, the default play path can be updated according to a current default play path. For example, an original default play path is SR→RA, when the interactive video progress to a default play sub-path AE1 corresponding to the RA, that is, when a video file corresponding to the RA has been played to the end and a video file corresponding to the AE1 starts to be played, the default play path can be updated to SR→RA→AE1. In this embodiment, by updating the default play path, in the process that a user does not select play paths, the current play paths which has been played can be continuously recorded, so that the next time the user enters the live broadcast room, subsequent contents of the interactive video can start to be played directly from behind the paths which has been played.

In one or more embodiments, a target play path selected by a client can be acquired; after a video file corresponding to the target play path is played, play path for the client are updated according to the target play path. Assuming that an original historical selection path is SR→RB, when the interactive video progress to a node B and a user selects a play sub-path BE4, after a video file corresponding to the BE4 starts to be played, the play path is updated to SR→RB→BE4. In this embodiment, by updating the play path, in the process that the user watches an interactive video, paths on which an interactive video has been currently played can be continuously recorded, so that the next time the user enters the live broadcast room, subsequent contents of the interactive video can start to be played based on the paths on which the interactive video has been currently played.

In an embodiment, the player 207 is further configured to, after updating the play paths, update one or more bullet-screen comment messages displayed on the client. Since bullet chat functioning scopes for play nodes may be different, after play paths are updated, bullet-screen comment messages displayed on a client need to be updated at the same time. Specifically, a target bullet chat functioning scope for a closest play node on the updated play paths can be acquired. When a current play path for a first client is within the target bullet chat functioning scope, bullet-screen comment messages sent by a second client for which current play path is within the target bullet chat functioning scope are displayed on the first client, and bullet-screen comment messages sent by a third client for which current play path is not within the target bullet chat functioning scope are shielded on the first client.

The node editor, video editor, video manager, instructor console, instruction controller, bullet chat processor and player shown in FIG. 8 can be implemented by software, or by hardware or by a combination of software and hardware. Taking the software implementation as an example, as an apparatus in a logical sense, it is formed by reading corresponding computer program instructions in a non-volatile memory into internal storage for running by a processor that processes files where the apparatus is located.

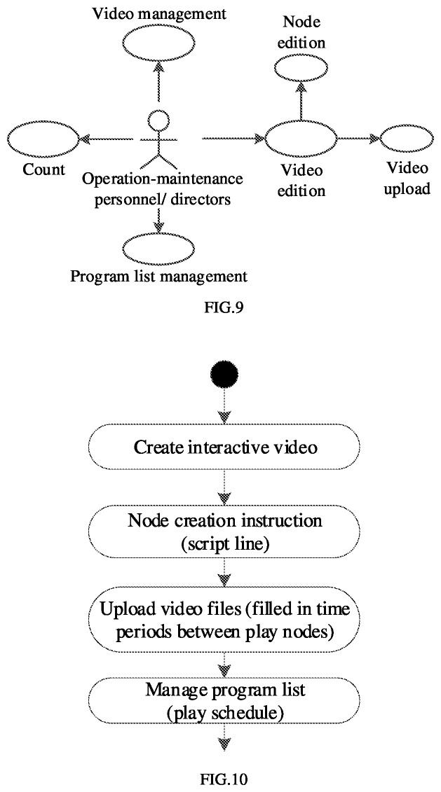

FIG. 9 is an architecture diagram illustrating partial functions of the live broadcast platform shown in FIG. 8. As shown in FIG. 9, operation-maintenance personnel or a director can perform video edition and node edition on the live broadcast platform, and then upload the edited interactive video to the live broadcast platform. If there are multiple interactive videos, the multiple interactive videos can be managed, and a play time and a play number information of each video can be managed through a program list management. In addition, a number of instruction operations performed by a client playing an interactive video, and/or a number of clients on each play sub-path can be counted.

FIG. 10 is a schematic diagram illustrating an interactive video creation process on the live broadcast platform shown in FIG. 8. As shown in this diagram, in the interactive video creation process, play nodes are first created according to a received node creation instruction, and time offsets of the play nodes are determined. The time offsets of the play nodes constitute a script timeline. Then, video files are uploaded for play paths between the play nodes to fill in time periods between the play nodes.

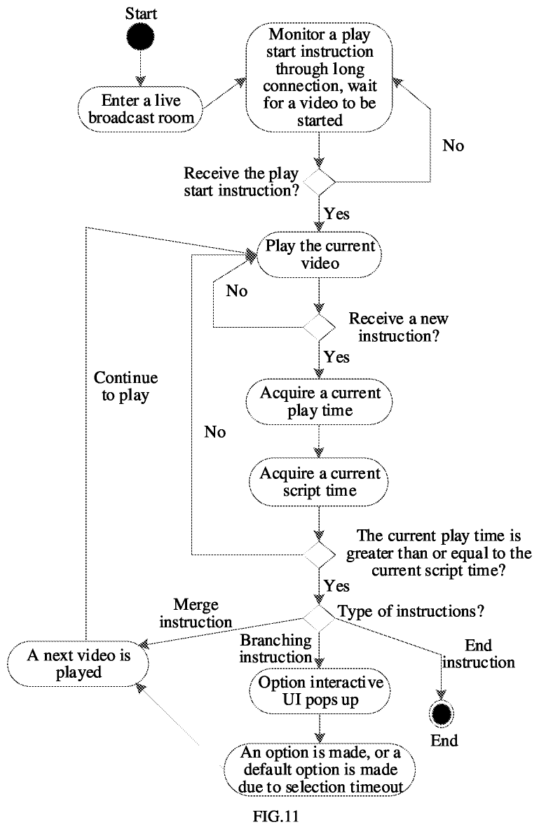

FIG. 11 is a schematic diagram illustrating an interactive video play process according to an embodiment of the present disclosure. A client, after entering a live broadcast room, can establish a long connection with a live broadcast platform, and monitor a play start instruction through the long connection to wait for an interactive video to be played. If the client receives the play start instruction, the interactive video at current time is played. After the client receives a new instruction (for example, a branching instruction), the live broadcast platform acquires a current play time (video_time) of playing the interactive video by the client, and a current script time (script_time) of the interactive video. If the current play time is greater than or equal to the current script time (video_time≥script_time), a type of the instruction is determined: For a branching instruction, an option interactive UI (User Interface) pops up on the client for a user to select a play path, or wait for selection timeout to automatically select a default option; For a merge instruction, a next video is played directly; For an end instruction, the play ends.

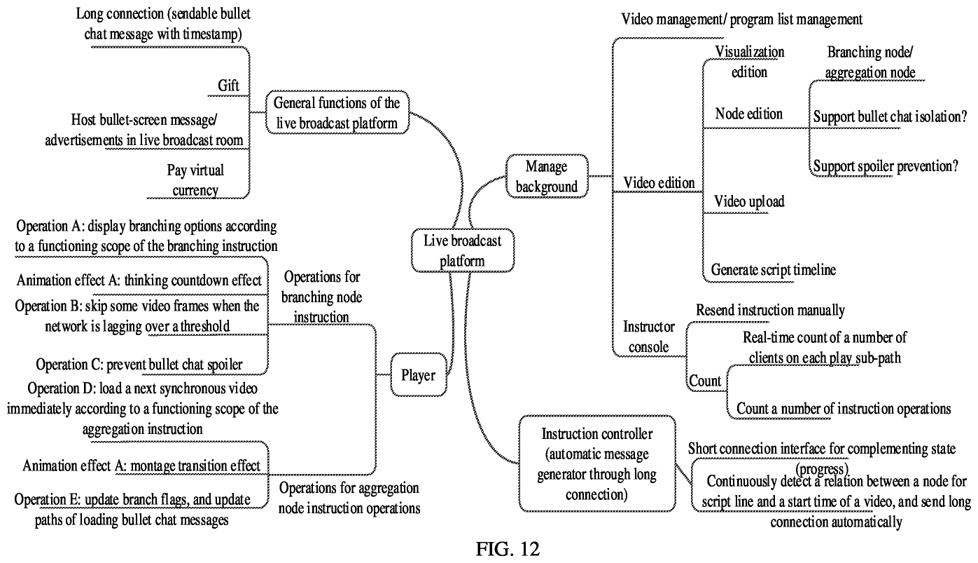

FIG. 12 is an architecture diagram illustrating an overall function of a live broadcast platform according to an embodiment of the present disclosure. In addition to the functions in the above-described embodiments, the live broadcast platform in this embodiment can be compatible with general functions of the live broadcast platform, such as giving gifts in a live broadcast room, sending host bullet-screen comment messages, playing advertisements in the live broadcast room, and paying virtual currency. In addition, some animation effects can be displayed at the time of progressing to branching nodes or aggregation nodes, for example, a thinking countdown effect when a user selects a play path, or a montage transition effect when switching to play video files on different play sub-paths.

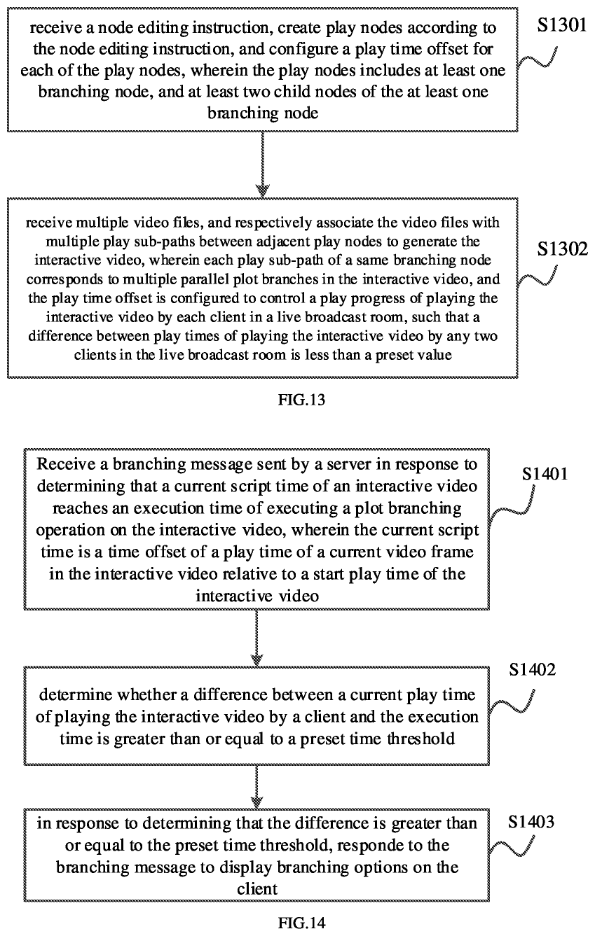

FIG. 13 is a flowchart illustrating an interactive video processing method according to an embodiment of the present disclosure. The method is based on a live broadcast platform described in any embodiment. The method includes step S1301 to step S1302.

At the step S1301, a node editing instruction is received, a play node is created according to the node editing instruction and a play time offset for each play node is set, where the play node includes at least one branching node, and at least two child nodes for the at least one branching node.

At the step S1302, multiple video files are received, and the video files are respectively associated with multiple play sub-paths between adjacent play nodes to generate an interactive video, where each play sub-path of a same branching node corresponds to multiple parallel plot branches in the interactive video, and the play time offset is configured to control a play progress of playing the interactive video by each client in a live broadcast room, such that a difference between play times of playing the interactive video by any two clients in the live broadcast room is less than a preset value.

For other embodiments of the above method, reference may be made to other embodiments of the live broadcast platform, which will not be repeated here.

According to the embodiments of the present disclosure, each play node can be edited on the live broadcast platform, and a play time offset for each play node can be set, so that the live broadcast platform, when playing an interactive video, can control the play progress for each client based on the play time offset. In this way, clients can discuss video contents with each other on a relatively unified timeline, thereby improving the interactivity of users in the live broadcast room when watching interactive videos.

According to some embodiments of the present disclosure, an interactive video play control method can be implemented on clients connected to a server of a live broadcast platform.

FIG. 14 is a flowchart illustrating an interactive video play control method according to an embodiment of the present disclosure. The method may include step S1401 to step S1403.

At the step S1401, a branching message, sent by a server when a current script time of an interactive video reaches an execution time when executing a plot branching operation on the interactive video, is received. where the current script time is a time offset of a play time of a current video frame in the interactive video relative to a start play time of the interactive video.

At the step S1402, it is determined whether a difference between a current play time of playing the interactive video by a client and the execution time is greater than or equal to a preset time threshold.

At the step S1403, if the difference is greater than or equal to the preset time threshold, in response to the branching message, branching options are displayed on the client.

During the play of the interactive video, the server continuously detects the current script time of the interactive video, and when the script time reaches the execution time of executing the plot branching operation on the interactive video, the server sends the branching message to the client by calling a long connection to notify the client that plot of the interactive video currently progresses to a branching node.

In the process of playing an interactive video by users, there usually exist network delay and/or lag. Therefore, there is a difference (i.e., a delay) between a “video experience line” of a user and a “script timeline”. However, in some cases, endless delay cannot be tolerated.

This is because different users need to watch interactive videos and interact with each other (for example, sending bullet-screen comment messages to each other) on a relatively unified timeline. In this way, users who watch interactive video at the same time can have communication and dialogue, further analyze plots, and express emotions and feelings. This requires that video contents watched by the users cannot differ greatly. If the video contents watched by the users differ greatly, the communication will become more and more difficult. For example, there is a funny punchline in a plot. San ZHANG laughs immediately after watching this punchline. Si LI watches the punchline after four or five minutes. Therefore, Si LI laughs five minutes later after San ZHANG laughs. In such a scenario, it is very difficult for San ZHANG and Si LI to exchange video experience and impression by sending bullet-screen comment messages. Therefore, it is necessary to limit the delay between different users.

Therefore, the client, after receiving the branching message, will first determine whether the difference between the current play time of playing the interactive video by the client and the execution time is greater than or equal to the preset time threshold. If the difference is greater than or equal to the preset time threshold, it indicates that current play delay on the client has been greater than an allowable tolerance duration, which is not beneficial to the communication of interactive video plots between clients in a unified time dimension. Therefore, in order to reduce the play delay on the client, after receiving the branching message, the client will display the branching options immediately in response to the branching message. At the same time, since the current play time has not reached the execution time, the interactive video will still continue to be played. That is to say, the branching options are displayed while the interactive video continues to be played. The branching options are used for the client to select a play path of the interactive video, and each branching option corresponds to one play path.

Further, if the difference between the current play time and the execution time is less than the preset time threshold, it is determined whether the current play time reaches the execution time. If the current play time reaches the execution time, in response to the branching message, the branching options are displayed on the client.

In this embodiment, if the difference between the current play time and the execution time is less than the preset time threshold, it indicates that the play delay on corresponding client is less than an allowable maximum duration (i.e., a tolerance duration). Therefore, after the current play time reaches the execution time, the branching options can be displayed on the client. That is to say, if the difference is less than the preset time threshold, after receiving the branching message, the client will not display the branching options thereon immediately in response to the branching message, but wait until contents of the interactive video prior to the branching node has been played, and thereafter, start to display the branching options thereon. If it is determined that the current play time does not reach the execution time, the interactive video continues to be played, and until the current play time reaches the execution time, the branching options are displayed on the client.

The tolerance duration can be set to 10 seconds. In practical applications, the 10-second tolerance duration is just an example, and this value can be adjusted based on actual experience and different business needs. For example, the tolerance duration on some play nodes can be 5 seconds, 20 seconds or 30 seconds. In particular, if play paths do not need to be merged into a unified ending, that is, subsequent contents of an interactive video do not need synchronization between users, the value of the tolerance duration can be a very large value.

In an embodiment, the client can count down a display time of the branching options, and after the countdown ends, a play path (i.e., a default play path) corresponding to a default branching option is automatically selected. Assuming that T represents the display countdown of the branching options, T1 represents the execution time, T2 represents the current play time, and T3 represents the time threshold (i.e., the tolerance duration), T=T3−(T1−T2).

In an embodiment, if the difference between the current play time and the execution time is greater than the preset time threshold, after receiving the branching message, the client can skip some frames of the interactive video according to the server. From the user perspective, “skipping some frames of the interactive video” makes users feel like the video suddenly “skipped”, for example, displayed at a previous moment is a picture at the 50^{th} second, but next moment, a picture at the 60^{th} second is suddenly displayed, which makes the users feel like a part of contents is “lost”, and the video skipped and continues to be played from contents at a later time. By skipping some frames of the interactive video, the play delay can be further reduced.

Optionally, in addition to the case where the client skips some frames of the interactive video after receiving the branching message, the client can skip some frames of the interactive video according to the server upon receiving the heartbeat packet sent by the server. The heartbeat packet can be periodically sent by the server at a preset time interval, for example, every 3 seconds.

The process of skipping some frames of the interactive video specifically includes: through a pre-established interface between the client and a Content Delivery Network (CDN), acquiring video contents starting from a target play time of the interactive video, where a difference between the target play time and the execution time is less than the time threshold (the tolerance duration); and playing the video contents by the client. For example, if the current play time is the 50^{th} second, the execution time is the 65^{th} second, and the time threshold is 10 seconds, the client can acquire video contents corresponding to the 60^{th} second of the interactive video through the pre-established interface between the client and the content delivery network, and then the client starts to play from the 60^{th} second of the interactive video. The contents starting to be played from the 60^{th} second of the interactive video are the video contents starting from the target play time. The values here are only examples, and are not limited thereto in practical applications.

In an embodiment, acquiring the video contents starting from the target play time of the interactive video includes: searching for the video contents starting from the target play time of the interactive video in a video buffer area; if having searched out the video contents, acquiring the video contents from the video buffer area; if having not searched out the video contents, obtaining the video contents starting from the target play time of the interactive video from the content delivery network through the interface.

For an interactive video in MP4 format, during the play for the interactive video, the client first obtains a piece of video contents from the CDN and buffers the piece of video contents locally. For example, when video contents from the 0^{th} second to the 20^{th} second of an interactive video are played, video contents from the 20^{th} second to the 40^{th} second of the interactive video can be obtained and buffered. Therefore, the client, when skipping some frames of the interactive video, can first search for the video contents starting from the target play time of the interactive video in a local buffer of the client. If the video contents are searched out, jump directly to the video contents and start to play the video contents. If the video contents are not searched out, it indicates that the video contents have not been buffered. Therefore, the video contents can be obtained from the CDN to the local buffer, and then the video contents starting from the target play time are read from the local buffer and played.

Videos in M3U8 format are similar to videos in MP4 format. For an interactive video in M3U8 format, video files of the interactive video are divided into multiple video clips. During the play of the interactive video, the client first obtains several video clips from the CDN and buffers the video clips locally. For example, when the first video clip is played, the second to fourth video clips can be buffered. Since the duration of each video clip is determined, the client, when skipping some frames of the interactive video, can first determine a video clip starting from the target play time, and search for the video clip in the buffer. If the video clip is searched out, the video clip is played directly from the target play time. If the video clip is not searched out, the video clip is obtained from the CDN and buffered, and then the video clip is read from the buffer and played from the target play time.

In an embodiment, after the branching options are displayed on the client, a selection instruction of a user for a branching option can be received, and in response to the selection instruction, a video content corresponding to a selected branching option in the interactive video is played. For example, for an interactive video shown in FIG. 1, if the user sends a selection instruction for an option 1, video content corresponding to the option 1 starts to be played.

In the embodiments of the present disclosure, when an interactive video is played in a live broadcast room, a unified timeline (referred to as a script timeline) is adopted for each client. The script timeline, also known as a “script line”, is an ideal time. From the perspective of a content creator, things happen at a relative time relative to time zero when an interactive video is played, for example, the creator hopes that one plot branch starts at the 10^{th} minute on a script, one plot aggregation appears at the 15^{th} minute on the script, and all contents end at the 30^{th} minute on the script. The emphasis here is the superscript “th”, which represents “relative time” or a time offset. However a time when a user watches a video is an absolute time, which is related to factors such as network status of each user.

The server sends the branching message to the client according to the script time to notify the client of whether a branching operation should be performed currently. The client compares the current play time of the interactive video with the execution time to know current delay on the client. When the delay exceeds the tolerance duration, the client displays the branching options thereon immediately after receiving the branching message. Then, the client skips some frames of the interactive video, which can reduce the delay of playing the interactive video by the client so that different clients can play the interactive video on a relatively unified timeline, and facilitate the interaction between the clients.

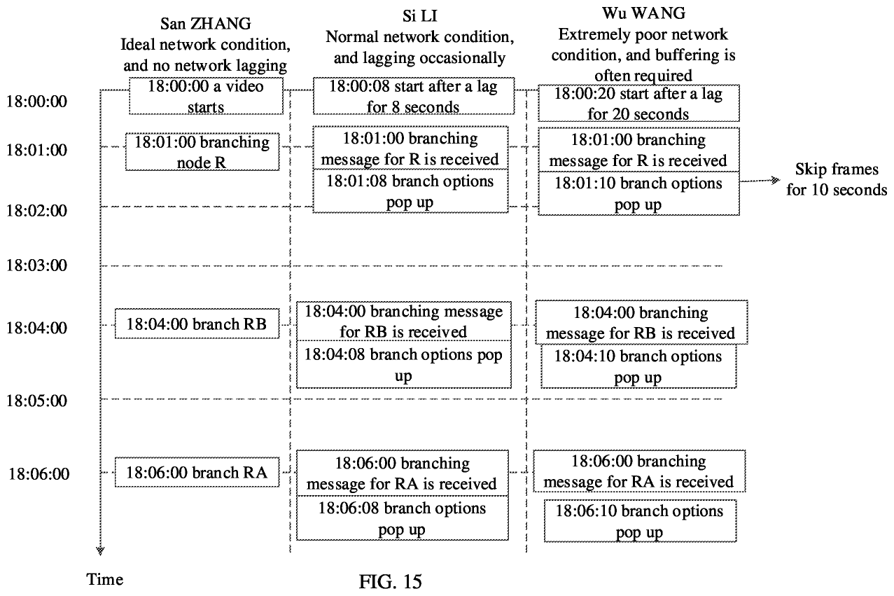

Referring to FIG. 15, a numerical embodiment is taken as an example below for description.

For example, taking the “script timeline” of 30 minutes as an example, contents of an interactive video will start to be played officially at 18:00:00 on Jul. 25, 2019.

In an ideal situation, assuming that the network of a user San ZHANG is in an excellent status and has no lag and delay in receiving information through a long connection, and San ZHANG makes a selection immediately when receiving a branch option interaction, San ZHANG may receive a branching message of a branching node R at an absolute time of 2019-07-25 18:01:00, and branching options of the node R are displayed. San ZHANG, if selecting a branching node B, receives a branching message of the branching node B at an absolute time of 2019-07-25 18:04:00, and branching options of the node B are displayed. San ZHANG, if selecting a branching node A, receives a branching message of the branching node A at an absolute time of 2019-07-25 18:06:00, and branching options of the node A are displayed.

In fact, because the ideal situation does not exist, and different users such as Si LI and Wu WANG have different network statuses, a time point of each of their branch selections may be several seconds or even ten or twenty seconds later than that in the example of San ZHANG in the ideal situation (2019-07-25 18:00:08; 2019-07-25 18:00:20; . . . ).

Assuming that when the user Si LI plays the interactive video, the network is lagging for 8 seconds (lag=8), which happens after the client of Si LI receives a play start instruction and when the interactive video just starts to be played, and assuming that there is no lag in 52 seconds from an absolute time of 2019-07-25 18:00:08 to an absolute time of 2019-07-25 18:01:00, at the absolute time of 2019-07-25 18:01:00, the video watched by the user Si LI has been played to the 52^{nd} second of a “video experience line” of the user Si LI (video_time=52).

At the same time, because an “instruction controller” of a server, after detecting a server time, determines that a “script timeline/script line” stored by the server has run to the 60^{th} second (script_time=60), the “instruction controller” will send a “branching” information through a long connection (this information records information for a receiver to display an branch selection interface and corresponding options when the video_time reaches (greater than or equal to) the 60^{th} second (a current script time reaches an execution time of executing a plot branching operation on the interactive video execute_time=60)).

Assuming that there is no delay for the user Si LI to receive the “branching” instruction, at the absolute time of 2019-07-25 18:01:00, the client of the user Si LI receives this instruction but does not display. This is because, at this time, video_time=52 of the user Si LI is less than execute_time=60 (where 60 can refer to a relative time of executing the branching instruction relative to time zero of the interactive video), which indicates that video contents watched by the user Si LI have not reached the condition of triggering the display of branching options. Therefore, nothing happens on a player interface at this time, and the player will continue to play the current video.

The time advances to an absolute time of 2019-07-25 18:01:01. At this time, video_time accumulates to 53, but still video_time<execute_time. The client of the user Si LI still does not display an interactive interface of the branching options, and continues to play the current video. The time elapses second by second, and continues to an absolute time of 2019-07-25 18:01:08. The video_time of the user Si LI accumulates to 60. At this time, video_time≥execute_time has been satisfied. Then, the interactive interface of the branching options pops up in the player of the client of the user Si LI, that is, the user Si LI is allowed to select A or B.

Further, assuming that an allowable tolerance duration is 10 seconds (waiting_duration=10, that is, a difference between videos watched by different users cannot exceed 10 seconds), and assuming that the network delay of Si LI is 8 seconds, and the network delay of Wu WANG is 20 seconds just at the beginning (assuming that the network of Wu WANG is lagging for 20 seconds, and thereafter will not be lagging until the interactive video has been played), at the absolute time of 2019-07-25 18:01:00, Si LI's video_time=52, and Wu WANG's video_time=40 (because the network of Wu WANG is lagging for 20 seconds (lag=20), Wu WANG watches only the first 40 seconds of the video contents).

The time elapses second by second, and continues to an absolute time of 2019-07-25 18:01:10. The video_time of Wu WANG accumulates only to 50. Although the condition of video_time≥script_time is not satisfied at this time, there is another condition, that is, a time difference between video_time and script_time cannot be greater than 10 seconds (waiting_duration=10). Therefore, at this time (video_time+waiting_duration≥script_time), the player of the client of Wu WANG does not need to wait for video_time=60, and instead, when video_time=50, that is, at 2019-07-25 18:01:10, immediately performs the following actions:

(1) the interactive interface of the branching options immediately pops up in the player, that is, the user Wu WANG is allowed to select A or B.

(2) the video skips some frames of the interactive video, that is, the played video immediately jumps to 10 seconds later. By skipping some frames of the interactive video, a difference between videos watched by Wu WANG and San ZHANG does not exceed 10 seconds.

In another embodiment, after branching options pop up, a countdown can be displayed. Still taking values in FIG. 15 as an example, assuming that after branching options pop up on the client of the user San ZHANG at 18:01:00, there is a normal 10-second countdown time, the user San ZHANG selects a branching option, and after the 10-second countdown (for example, count_down=10), a next video starts to be played at 18:01:10. The client of the user Si LI has a delay of 8 seconds when starting to play. After branching options pop up on the client of the user Si LI at 18:01:08, there is a 2-second countdown time (count_down—lag=10−8=2). Thereafter, even if Si LI makes a selection within 2 seconds, he/she still has to wait until the countdown is reduced to 0 (i.e., 2019-07-25 18:01:10), and then a next video clip corresponding to a branch selected by Si LI is played. The client of the user Wu WANG has a delay of 20 seconds when starting to play. In order to make a difference among videos watched by the users Wu WANG, San ZHANG and Si LI not exceed 10 seconds, branching options can pop up on the client of the user Wu WANG at 18:01:10, and some frames of the interactive video are immediately skipped for 10 seconds (waiting_duration—lag=10−20=−10) to start to play a next video, without displaying a countdown. At this time, the video contents watched by Wu WANG are asynchronous with the branching options that pop up on an interactive interface, that is, the video contents watched by Wu WANG have not reached the time 18:01:20 when the branching options should pop up, but the branching options still forcibly pop up at 18:01:10; or the branching options can pop up in advance on the client of Wu WANG at 18:01:00 (at this time, Wu WANG's video_time=40, video_time+count_down+waiting_duration≥script_time), and a 10-second countdown is displayed. Similarly, at this time, the video contents watched by Wu WANG are asynchronous with the branching options that pop up on the interactive interface, that is, the video contents watched by Wu WANG have not reached the time 18:01:20 when the branching options should pop up, but the branching options still forcibly pop up at 18:01:00, and at 18:01:10 (Wu WANG's video_time=50), some frames of the interactive video are immediately skipped for 10 seconds. While the branching options that are counted down from 10 appear on the client of the user Wu WANG at 18:01:00, contents of the 40^{th} to 50^{th} second of the last video will still continue to be played. By skipping some frames of the interactive video, a difference between videos watched by Wu WANG and San ZHANG does not exceed 10 seconds.

The technical features in the above embodiments can be combined arbitrarily, as long as there is no conflict or contradiction between the combinations of features, which, due to space limitations, are not described one by one. Therefore, any combination of the technical features in the above embodiments falls within the scope of the present disclosure.

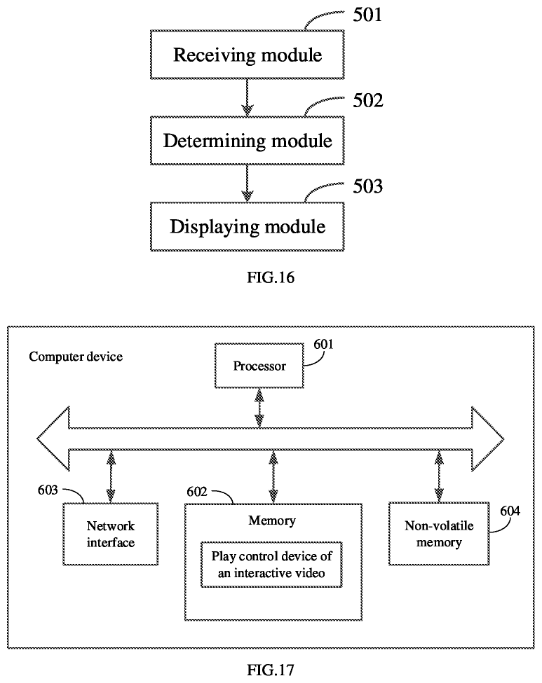

FIG. 16 is a block diagram illustrating an interactive video play control apparatus according to an embodiment of the present disclosure. The apparatus may include a receiving module 501, a determining module 502 and a displaying module 503.

The receiving module 501 is configured to receive a branching message sent by a server when a current script time of an interactive video reaches an execution time of executing a plot branching operation on the interactive video, where the current script time is a time offset of a play time of a current video frame in the interactive video relative to a start play time of the interactive video.

The determining module 502 is configured to determine whether a difference between a current play time of playing the interactive video by a client and the execution time is greater than or equal to a preset time threshold.

The displaying module 503 is configured to, if the difference is greater than or equal to the preset time threshold, in response to the branching message, display branching options on the client.

For the implementation process of functions and effects of each module in the apparatus, reference may be made to that of corresponding steps in the method, which will not be repeated here.

For the apparatus examples, since they basically correspond to the method examples, reference may be made to the partial description of the method examples. The apparatus examples described above are merely illustrative, where the modules described as separate components may or may not be physically separated, and the components displayed as modules may or may not be physical modules, i.e., may be located in one place or may be distributed to multiple network modules. Some or all of the modules may be selected according to actual needs to achieve the objectives of the present disclosure. Those of ordinary skill in the art can understand and implement the present disclosure without any creative effort.

The apparatus examples of the present disclosure can be applied to computer devices, such as servers or terminal devices. The apparatus examples can be implemented by software, or by hardware or by a combination of software and hardware. Taking the software implementation as an example, as an apparatus in a logical sense, it is formed by reading corresponding computer program instructions in a non-volatile memory into internal storage for running by a processor that processes files where the apparatus is located. From a hardware perspective, as shown in FIG. 17, which is a hardware structure diagram illustrating a computer device where an interactive video play control apparatus is located according to an embodiment of the present disclosure, in addition to a processor 601, a memory 602, a network interface 603 and a non-volatile memory 604 shown in FIG. 17, a server or electronic device where the apparatus is located in the embodiment may include other hardware usually according to actual functions of the computer device, which will not be repeated here.

Correspondingly, an embodiment of the present disclosure provides a computer storage medium having a program stored thereon, where the program is executed by a processor to implement the method in any of the above-described embodiments.

Correspondingly, an embodiment of the present disclosure provides a client, including a memory, a processor, and a computer program stored in the memory and running on the processor, where the program is executed by the processor to implement the method in any of the above-described embodiments.

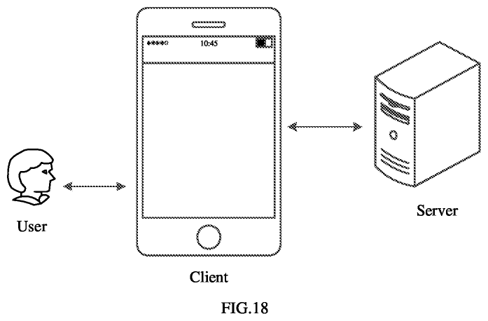

As shown in FIG. 18, an embodiment of the present disclosure provides an interactive video play control system, including: a server; and a plurality of clients, each of the clients including a processor and a memory for storing a processor-executable computer program, where the computer program is executed by a processor to implement the method in any of the above-described embodiments, where the server is configured to send a branching message to each of the clients when a current script time of an interactive video reaches an execution time of executing a plot branching operation on the interactive video.

In some examples, any live broadcast platform according to the above-described embodiments may be implemented on the server.

The technical features in the above embodiments can be combined arbitrarily, as long as there is no conflict or contradiction between the combinations of features, which, due to space limitations, are not described one by one. Therefore, any combination of the technical features in the above embodiments falls within the scope of the present disclosure.

According to the embodiments of the present disclosure, after the branch message sent by the server is received, it is determined whether the difference between the current play time of playing the interactive video by the client and the execution time is greater than or equal to the preset time threshold. If the difference is greater than or equal to the preset time threshold, the branching options are immediately displayed on the client, instead of waiting until the current play time reaches the execution time of executing the plot branching operation on the interactive video and then displaying the branching options on the client. In this way, the delay of playing the interactive video by the client is reduced, so that different clients can play the interactive video on a relatively unified timeline, which facilitates the interaction between the clients.

The embodiments of the present disclosure may take the form of a computer program product implemented on one or more storage media (including but not limited to a disk storage, a CD-ROM, an optical storage, and the like) having program codes included therein. Computer usable storage media include permanent and non-permanent, removable and non-removable media, and storage of information can be accomplished by any method or technology. Information may be computer readable instructions, data structures, program modules, or other data. Examples of computer storage media include, but are not limited to, a phase change random access memory (PRAM), a static random access memory (SRAM), a dynamic random access memory (DRAM), other types of random access memory (RAM), a read only memory (ROM), an electrically erasable programmable read only memory (EEPROM), a flash memory or other memory technology, a compact disc read only memory (CD-ROM), a digital versatile disc (DVD) or other optical storage, a magnetic tape cartridge, a magnetic tape/disk storage or other magnetic storage device or any other non-transmission medium that can be used to store information that can be accessed by a computing device.

Other embodiments of the present disclosure will be readily apparent to those skilled in the art after considering the specification and practicing the contents disclosed herein. The present application is intended to cover any variations, uses, or adaptations of the present disclosure, which follow the general principle of the present disclosure and include common knowledge or conventional technical means in the art that are not disclosed in the present disclosure. The specification and examples are to be regarded as illustrative only. The true scope and spirit of the present disclosure are pointed out by the following claims.

1. An interactive video play control method, comprising:
receiving a branching message sent by a server in response to determining that a current script time of an interactive video reaches an execution time of executing a plot branching operation on the interactive video, wherein the current script time is a time offset of a play time of a current video frame in the interactive video relative to a start play time of the interactive video;
determining whether a difference between a current play time of playing the interactive video by a client and the execution time is greater than or equal to a preset time threshold; and
in response to determining that the difference is greater than or equal to the preset time threshold, responding to the branching message to display branching options on the client.

2. The method according to claim 1, further comprising:
in response to determining that the difference is less than the preset time threshold, determining whether the current play time reaches the execution time; and
in response to determining that the current play time reaches the execution time, responding to the branching message to display the branching options on the client.

3. The method according to claim 2, further comprising:
in response to determining that the current play time does not reach the execution time, continuing to play the interactive video, and until the current play time reaches the execution time, displaying the branching options on the client.

4. The method according to claim 3, wherein a display countdown of the branching options is set to:
T=T3−(T1−T2),
wherein T represents the display countdown of the branching options, T1 represents the execution time, T2 represents the current play time, and T3 represents the time threshold.

5. The method according to claim 1, further comprising:
in response to determining that the difference is greater than the preset time threshold, upon receiving the branching message, skipping some frames of the interactive video according to the server.

6. The method according to claim 1, further comprising:
in response to determining that the difference is greater than the preset time threshold, upon receiving a heartbeat packet sent by the server, skipping some frames of the interactive video according to the server.

7. The method according to claim 6, wherein the heartbeat packet is periodically sent by the server at a preset time interval.

8. The method according to claim 5, wherein skipping some frames of the interactive video according to the server comprises:
through a pre-established interface between the client and a content delivery network, acquiring video contents starting from a target play time of the interactive video, wherein a difference between the target play time and the execution time is less than the time threshold; and
playing the video contents.

9. The method according to claim 8, wherein acquiring the video contents comprises:
searching for the video contents starting from the target play time of the interactive video in a video buffer area;
in response to searching out the video contents, acquiring the video contents from the video buffer area; and
in response to not searching out the video contents, obtaining the video contents starting from the target play time of the interactive video from the content delivery network through the pre-established interface.

10. The method according to claim 1, further comprising:
receiving a selection instruction of a user for the branching options; and
in response to the selection instruction, playing video contents corresponding to a selected branching option of the interactive video.

11-28. (canceled)

29. An interactive video processing method, applied to a live broadcast platform, comprising:
receiving a node editing instruction;
creating play nodes according to the node editing instruction;
configuring a play time offset for each of the play nodes, wherein the play nodes includes at least one branching node, and at least two child nodes for the at least one branching node;
receiving multiple video files; and
associating, respectively, the video files with multiple play sub-paths between adjacent play nodes to generate an interactive video, wherein each play sub-path of a same branching node corresponds to multiple parallel plot branches in the interactive video, and the play time offset is configured to control a play progress of playing the interactive video by each client in a live broadcast room, such that a difference between play times of playing the interactive video by any two clients in the live broadcast room is less than a preset value.

30. The method according to claim 29, further comprises:
receiving play time information and play number information of each interactive video; and
associating the play time information and the play number information of each interactive video with corresponding interactive video; wherein the play time information of the interactive video comprises information indicating a starting play time of the interactive video.

31. The method according to claim 29, further comprises:
in response to receiving an interactive video editing instruction, during playing of the interactive video, performing at least one of: inserting a play node in the interactive video, deleting a play node from the interactive video, or inserting an advertisement in the interactive video.

32. The method according to claim 29, further comprises:
acquiring a server time; and
in response to determining that the server time reaches a play time indicated by play time information of the interactive video, sending an interactive video play start instruction to a client in the live broadcast room through a long connection pre-established with the client, wherein the interactive video play start instruction is configured to instruct the client to access a video address of the interactive video to start to play the interactive video.

33. The method according to claim 29, further comprises:
in response to a short connection establishment request sent by a client in the live broadcast room, establishing a short connection with the client; and
receiving a play request for starting to play the interactive video sent by the client through the short connection.

34. The method according to claim 29, further comprises:
acquiring a bullet-screen comment message sent by a client in the live broadcast room;
acquiring a current play path of playing the interactive video when the client sends the bullet-screen comment message; and
sending the bullet-screen comment message to other clients in the live broadcast room on the current play path.

35. The method according to claim 34, further comprises:
acquiring a second time offset between a time of sending a bullet-screen comment message by a second client in the live broadcast room and a start play time of the interactive video; and
in response to determining a first time offset between a current play time of a first client in the live broadcast room and the start play time of the interactive video is less than the second time offset, sending the bullet-screen comment message sent by the second client to the first client.

36. The method according to claim 29, further comprises:
sending a current script time of the interactive video to the client; and
in response to determining that a difference between the current script time and an actual play time of currently playing the interactive video is greater than a second preset time threshold, skipping some frames of the interactive video according to the server;
wherein the current script time is a time offset of a play time of a current video frame in the interactive video relative to a start play time of the interactive video.

37. The method according to claim 29, further comprises:
acquiring a bullet chat white list of a first client in the live broadcast room, wherein the bullet chat white list is used to store a list of preset play paths, and a bullet-screen comment message sent by any client on the preset play paths is allowed to be displayed on the first client;
in response to receiving a bullet-screen comment message sent by a second client in the live broadcast room, determining whether a current play path of the second client is in the bullet chat white list; and
in response to determining that the current play path of the second client is not in the bullet chat white list, preventing the bullet-screen comment message sent by the second client from being sent to the first client.

38. The method according to claim 29, further comprises:
storing a bullet chat functioning scope for each play node; and
in response to determining that a current play path for a first client in the live broadcast room is within the bullet chat functioning scope, preventing a bullet-screen comment message sent by a second client in the live broadcast room for which current play path is not within the bullet chat functioning scope from being sent to the first client.
